(19) United States
(12) Patent Application Publication
(10) Pub. No.: US 2020/0338696 A1
(43) Pub. Date: Oct. 29, 2020

(54) INTERNAL TOOTH TYPE RATCHET SCREWDRIVER

(71) Applicant: NINGBO HONY PLASTIC TECHNOLOGY CO., LTD, Ningbo (CN)

(72) Inventor: Wenbing Ge, Ningbo (CN)

(21) Appl. No.: 16/393,940

(22) Filed: Apr. 24, 2019

(51) Int. Cl. B25B 15/04

(52) U.S. Cl. CPC B25B 15/04

(57) ABSTRACT

An internal tooth type ratchet screwdriver includes a handle and a ratchet head, where the handle is provided with a ratchet seat, a first pawl and a second pawl; the bottom of the ratchet head is outwardly sleeved over the ratchet seat and teeth are formed on an inner wall surface; the first pawl and the second pawl have the same structure; one end of the outer ring of the first pawl is provided with a ratchet tooth structure; the end of the ratchet seat is provided with an inner core which is adapted to the structure of the inner wall of the first pawl; an outer ring at one side of the inner core is provided with an arc-shaped barrier strip; an installation seat is formed between the inner core and the arc-shaped barrier strip; the ratchet seat is outwardly clamped with a reversing ring.

### BACKGROUND

### Technical Field

The disclosure relates to a screwdriver, and particularly to an internal tooth type ratchet screwdriver.

### Related Art

A screwdriver serves as a tool for tightening and screwing up a screw. In the prior art, the screwdriver for installing and detaching the screw is generally a hand-operated screwdriver. A hand can only rotate in a certain limitation, and cannot always rotate in one direction, so when this tool is utilized, the hand generally rotates the handle of the tool toward an expected direction, and then the hand reversely rotates to relocate the tool so as to enter a next cycle. Reverse rotation of the hand is achieved as follows: the handle of the tool is loosened and then grasped again, a spindle is not moved when the handle is reversely rotated, or the hand-held tool is separated from the screw, and then the screw is inserted into the tool again to be rotated, so that the whole rotation is inconvenient.

Thus, at present, the tool is provided with a one-way device such as a ratchet mechanism to form a ratchet screwdriver. This structure allows the hand of a user not to need to be separated from the handle of the screwdriver, or insert the screw again to be rotated after the screwdriver is separated from the screw. However, the ratchet screwdriver in the prior art generally adopts a ratchet one-way transmission device, and therefore such a ratchet screwdriver can only tighten the screw in a single direction but not in a reverse direction. In order to achieve a set of functions, a plurality of groups of ratchet transmission mechanisms is provided in the ratchet screwdriver, so that rotation of the screw in different directions can be achieved after the ratchet screwdriver is regulated.

However, the existing ratchet structure is complicated in internal structure and relatively high in production cost. Furthermore, the internal structure is unstable, and therefore a non-rotation situation may occur when a large torque force is stressed, and reliability is low. Thus, our company develops “INTERNAL TOOTH TYPE RATCHET SCREWDRIVER” of the disclosure to solve the problems in the prior art.

### SUMMARY

The technical problem to be solved by the disclosure is to provide an internal tooth type ratchet screwdriver, in order to achieve a high torque force and a high reliability and solve the problems of complicated structure and high cost.

The technical solution to solve the above technical problem of the disclosure is as follows: provided is an internal tooth type ratchet screwdriver, including a handle and a ratchet head whose head acts on a bolt, where the handle is provided with a ratchet seat, a first pawl and a second pawl; the bottom of the ratchet head is outwardly sleeved over the ratchet seat and teeth are formed on the inner wall surface of the ratchet head; the first pawl and the second pawl have the same structure and are mounted in the ratchet seat in opposite directions; the first pawl is of an arc-shaped strip-like structure, and one end of the outer ring of the first pawl is provided with a ratchet tooth structure; the end of the ratchet seat is provided with an inner core which is adapted to the structure of the inner wall of the first pawl; an outer ring at one side of the inner core is provided with an arc-shaped barrier strip; an installation seat is formed between the inner core and the arc-shaped barrier strip; the first pawl and the second pawl are mounted on the installation seat, and the ratchet tooth structure at the end is exposed out of the arc-shaped barrier strip; the ratchet seat is outwardly clamped with a reversing ring; the inner side surface of the reversing ring is provided with a paddle located between the end of the first pawl and the end of the second pawl; the reversing ring rotates so that the paddle acts on the end of the first pawl or the end of the second pawl, and consequently the end of the first pawl or the end of the second pawl is engaged with the ratchet head.

A further preferred solution of the disclosure is as follows: the inner core and the ratchet seat are not coaxial; two side surfaces of the inner core are arc-shaped surfaces having a diameter larger than that of the ratchet seat; the inner side surface of the first pawl and the inner side surface of the second pawl respectively fit the arc-shaped surfaces at the two sides of the inner core.

A further preferred solution of the disclosure is as follows: the first pawl and the second pawl are oppositely provided; the other end of the first pawl is provided with a protrusion for connecting a spring; the other end of the first pawl and the other end of the second pawl are connected through the spring.

A further preferred solution of the disclosure is as follows: a protruded seat for mounting the spring is arranged in the middle of the installation seat; the spring is disposed on the protruded seat; the first pawl and the second pawl are located at two sides of the protruded seat.

A further preferred solution of the disclosure is as follows: the inner wall surface of the reversing ring is provided with a plurality of grooves; the ratchet seat is connected with a latching element through an elastic element; the latching element acts on one of the grooves; the reversing ring rotates so that the latching element shifts among the plurality of grooves.

A further preferred solution of the disclosure is as follows: the outer surface of the ratchet seat is provided with a recess; the latching element is mounted in the recess through the elastic element; the latching element is a steel ball.

A further preferred solution of the disclosure is as follows: the head part of the handle is provided with a notch; the outer wall surface of the ratchet seat is provided with a raised strip; the notch is adapted to the structure of the outer surface of the ratchet seat; the ratchet seat is inserted into the notch and fixed in circumferential and radial directions.

A further preferred solution of the disclosure is as follows: the head part of the handle is linked to the reversing ring; the reversing ring is linked to the ratchet head; all of the handle, the reversing ring and the ratchet head are connected by contact.

A further preferred solution of the disclosure is as follows: the surface of the ratchet seat is provided with a fixation element connected with a snap spring; the ratchet head is clamped at the periphery of the ratchet seat through the fixation element.

Compared with the prior art, the disclosure has the advantages that the handle is provided with the ratchet seat, the first pawl and the second pawl, and the bottom of the ratchet head is outwardly sleeved over the ratchet seat; teeth are formed on the inner wall surface of the ratchet head, the ratchet tooth structures of the ends of the first pawl and the second pawl are exposed out of the arc-shaped barrier strips, and the end of the first pawl or the end of the second pawl is engaged with the ratchet head; limitation on rotation of the ratchet head in different directions is achieved by providing the first pawl and the second pawl; when the first pawl acts on the ratchet head, the first pawl prevents the ratchet head from rotating anticlockwise, the ratchet head clockwise rotates, the first pawl can be separated from the ratchet head, and the ratchet head freely rotates; when the second pawl acts on the ratchet head, the second pawl prevents the ratchet head from rotating clockwise; the ratchet head anticlockwise rotates, the second pawl can be separated from the ratchet head, and the ratchet head freely rotates. The screwdriver provided by the disclosure is few in involved parts, few in whole structure and low in cost. In the disclosure, the ratchet seat is provided, the end of the ratchet seat is provided with the inner core which is adopted to the structure of the internal wall of the first pawl, an outer ring at one side of the inner core is provided with an arc-shaped barrier strip, and an installation seat is formed between the inner core and the arc-shaped barrier strip. The first pawl and the second pawl have the same structure and are mounted in the ratchet seat in opposite directions, the first pawl is of an arc-shaped strip-like structure, and one end of the outer ring of the first pawl is provided with a ratchet tooth structure, the first pawl and the second pawl are mounted on the installation seat and the ratchet tooth structures at the ends are exposed out of the arc-shaped barrier strips. The first pawl and the second pawl move in the arc-shaped installation seat of the ratchet seat so that the whole motion structure is extremely stable. When being stressed, the first pawl and the second pawl are more tightly clamped in an eccentric structure formed by the installation seat, and a torsion force is increased like a wedge block. The disclosure achieves a high torsion force and a high reliability.

### BRIEF DESCRIPTION OF THE DRAWINGS

The following further describes the present invention in detail with reference to the accompanying drawings and preferred embodiments. However, a person skilled in the art shall understand that these accompanying drawings are drawn to explain the preferred embodiments, and therefore should not be construed as a limitation to the scope of the present invention. In addition, unless otherwise specified, the accompanying drawings are only intended to be illustrative of the composition or construction of the described subject matter, and may include an exaggerated display, and the accompanying drawings are not necessarily drawn to scale.

FIG. 1 is an exploded view according to the disclosure;

FIG. 2 is a structural diagram according to the disclosure;

FIG. 3 is a cross section view taken along the section AA of FIG. 2;

FIG. 4 is a cross section view taken along the section BB of FIG. 2;

FIG. 5 is a cross section view taken along the section CC of FIG. 2;

FIG. 6 is a structural diagram of a reversing ring;

FIG. 7 is a structural diagram of a first pawl;

FIG. 8 is a structural diagram of a ratchet head; and

FIG. 9 is a structural diagram of a ratchet seat.

### DETAILED DESCRIPTION

The following describes the present invention in detail with reference to the accompanying drawings.

To make the objectives, technical solutions, and advantages of the present invention clearer and more comprehensible, the following further describes the present invention in detail with reference to the accompanying drawings and the embodiments. It should be understood that the specific embodiments herein are provided for describing the present invention and not intended to limit the present invention.

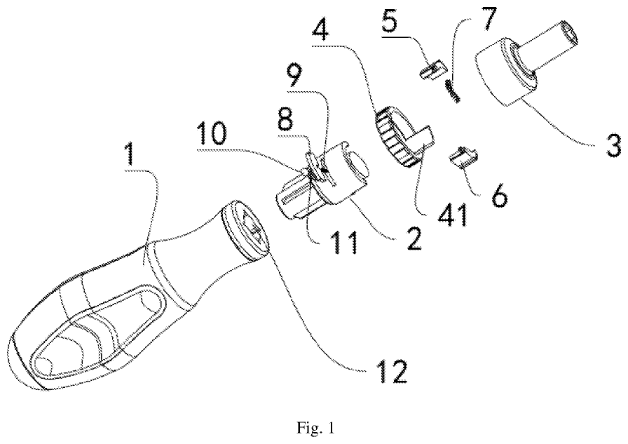

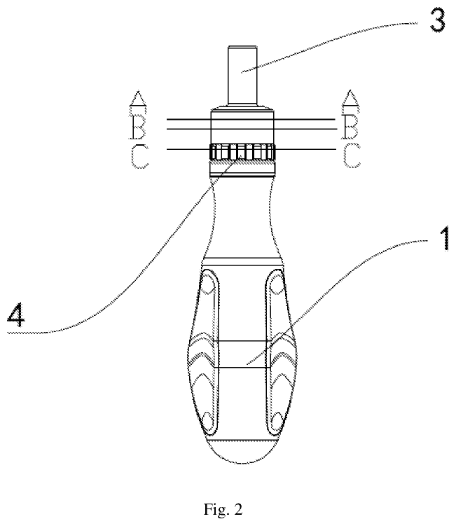

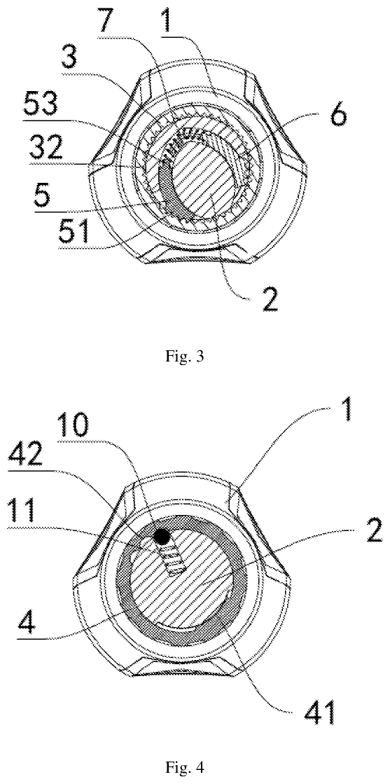

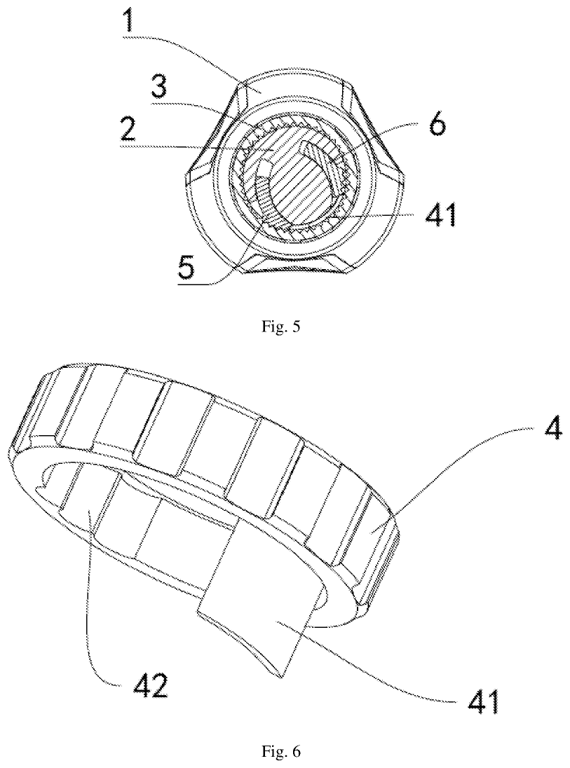

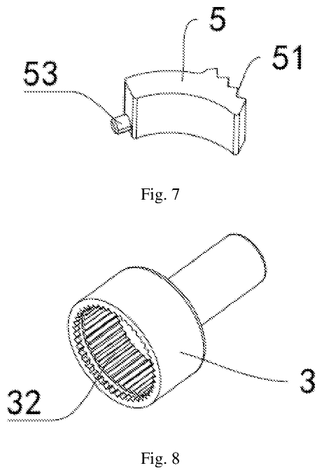

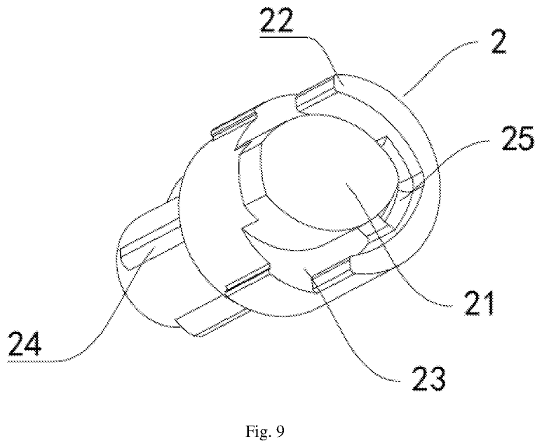

As shown in FIG. 1 to FIG. 9, an internal tooth type ratchet screwdriver includes a handle 1 and a ratchet head 3 whose head acts on a bolt. The handle 1 is provided with a ratchet seat 2, a first pawl 5 and a second pawl 6. The bottom of the ratchet head 3 is outwardly sleeved over the ratchet seat 2 and teeth 32 are formed on the inner wall surface of the ratchet head 3. The first pawl 5 and the second pawl 6 have the same structure and are mounted in the ratchet seat 2 in opposite directions. The first pawl 5 is of an arc-shaped strip-like structure, and one end of the outer ring of the first pawl is provided with a ratchet tooth structure 51. The end of the ratchet seat 2 is provided with an inner core 21 which is adapted to the structure of the inner wall of the first pawl 5. An outer ring at one side of the inner core 21 is provided with an arc-shaped barrier strip 22. An installation seat 23 is formed between the inner core 21 and the arc-shaped barrier strip 22. The first pawl 5 and the second pawl 6 are mounted on the installation seat 23, and the ratchet tooth structures 51 at the ends are exposed out of the arc-shaped barrier strip 22. The ratchet seat 2 is outwardly clamped with a reversing ring 4. The inner side surface of the reversing ring 4 is provided with a paddle 41 located between the end of the first pawl 5 and the end of the second pawl 6. The reversing ring 4 rotates so that the paddle 41 acts on the end of the first pawl 5 or the end of the second pawl 6, and consequently the end of the first pawl 5 or the end of the second pawl 6 is engaged with the ratchet head 3.

The inner core 21 and the ratchet seat 2 are not coaxial. Two side surfaces of the inner core 21 are arc-shaped surfaces having a diameter larger than that of the ratchet seat 2. The inner side surface of the first pawl 5 and the inner side surface of the second pawl 6 respectively fit the arc-shaped surfaces at the two sides of the inner core 21. The outer wall surface of the inner core 21 of the disclosure is adapted to the inner wall surface structures of the first pawl 5 and the second pawl 6. The first pawl 5 and the second pawl 6 are of arc-shaped strip-like structures having a diameter larger than that of the ratchet seat 2. Thus, the structure of the inner core 21 is a structure whose one end is sharp and elliptic-like, while the edge of the inner core 21 is not beyond the edge of the ratchet seat 2, and thus the other end of the inner core 21 is flushed with the ratchet seat 2.

The first pawl 5 and the second pawl 6 are oppositely provided. The other end of the first pawl 5 is provided with a protrusion 53 for connecting a spring 7. The other end of the first pawl 5 and the other end of the second pawl 6 are connected through the spring 7. The spring 7 is provided, so that the first pawl 5 or the second pawl 6 can return back to an original position after the paddle 41 is moved to achieve the engaging with the ratchet head 3.

A protruded seat 25 for mounting the spring 7 is arranged in the middle of the installation seat 23. The spring 7 is disposed on the protruded seat 25. The first pawl 5 and the second pawl 6 are located at two sides of the protruded seat 25. The protruded seat 25 is provided for mounting the spring 7 and simultaneously restricting the motion limit of the first pawl 5 and the second pawl 6.

The inner wall surface of the reversing ring 4 is provided with a plurality of grooves 42. The ratchet seat 2 is connected with a latching element 10 through an elastic element 11. The latching element 10 acts on one of the grooves 42. The reversing ting 4 rotates so that the latching element 10 shifts among the plurality of grooves 42. In the disclosure, three grooves 42 are provided, and the latching element 10 acts on the grooves 42 at two sides to respectively achieve the effect that the ratchet head 3 is clockwise non-rotatable and anticlockwise non-rotatable. The latching element 10 acts on the groove 42 in the middle, at this moment, none of the first pawl 5 and the second pawl 6 is engaged with the ratchet head 3, so that the ratchet head 3 can be bi-directionally rotated.

The outer surface of the ratchet seat 2 is provided with a recess. The latching element 10 is mounted in the recess through the elastic element 11. The latching element 10 is a steel ball. The recess and the steel ball structure are provided to achieve rotation of the reversing ring 4 under the action of an external force, and clamping instead of moving is realized without the external force.

The head part of the handle 1 is provided with a notch 12. The outer wall surface of the ratchet seat 2 is provided with a raised strip 24. The notch 12 is adapted to the structure of the outer surface of the ratchet seat 2. The ratchet seat 2 is inserted into the notch 12 and fixed in circumferential and radial directions. The ratchet seat 2 is singly provided, which is convenient for production and machining of parts. The notch 12 is provided to achieve the axial mounting of the ratchet seat 2 so as to be fixed in circumferential and radial directions, and therefore the structure is reliable when the bolt is rotated.

The head part of the handle 1 is linked to the reversing ring 4. The reversing ring 4 is linked to the ratchet head 3. All of the handle 1, the reversing ring 4 and the ratchet head 3 are connected by contact. The whole appearance of the screwdriver of the disclosure is simple and generous, and the reversing ring 4 is convenient to rotate and is not limited by the ratchet head 3 and the handle 1.

The surface of the ratchet seat 2 is provided with a fixation element 8 connected with a snap spring 9. The ratchet head 3 is clamped at the periphery of the ratchet seat 2 through the fixation element 8.

The present invention is described above in detail. The principles and the embodiments of the present invention have been described herein with reference to specific examples, and the description of the above embodiments is only to assist in understanding the present invention and its core idea. It should be noted that a person of ordinary skill in the art can make various improvements and modifications to the present invention without departing from the principles of the present invention, and these improvements and modifications also fall within the protection scope of the claims of the present invention.

What is claimed is:

1. An internal tooth type ratchet screwdriver, comprising a handle and a ratchet head whose head acts on a bolt, wherein the handle is provided with a ratchet seat, a first pawl and a second pawl; a bottom of the ratchet head is outwardly sleeved over the ratchet seat and teeth are formed on an inner wall surface of the ratchet head; the first pawl and the second pawl have a same structure and are mounted in the ratchet seat in opposite directions; the first pawl is of an arc-shaped strip-like structure, and one end of an outer ring of the first pawl is provided with a ratchet tooth structure; an end of the ratchet seat is provided with an inner core which is adapted to a structure of an inner wall of the first pawl; an outer ring at one side of the inner core is provided with an arc-shaped barrier strip; an installation seat is formed between the inner core and the arc-shaped barrier strip; the first pawl and the second pawl are mounted on the installation seat, and the ratchet tooth structure at the end is exposed out of the arc-shaped barrier strip; the ratchet seat is outwardly clamped with a reversing ring; an inner side surface of the reversing ring is provided with a paddle located between an end of the first pawl and an end of the second pawl; the reversing ring rotates so that the paddle acts on the end of the first pawl or the end of the second pawl, and consequently the end of the first pawl or the end of the second pawl is engaged with the ratchet head.

2. The internal tooth type ratchet screwdriver according to claim 1, wherein the inner core and the ratchet seat are not coaxial; two side surfaces of the inner core are arc-shaped surfaces having a diameter larger than that of the ratchet seat; an inner side surface of the first pawl and an inner side surface of the second pawl respectively fit the arc-shaped surfaces at the two sides of the inner core.

3. The internal tooth type ratchet screwdriver according to claim 1, wherein the first pawl and the second pawl are oppositely provided; the other end of the first pawl is provided with a protrusion for connecting a spring; the other end of the first pawl and the other end of the second pawl are connected through the spring.

4. The internal tooth type ratchet screwdriver according to claim 3, wherein a protruded seat for mounting the spring is further arranged in a middle of the installation seat; the spring is disposed on the protruded seat; the first pawl and the second pawl are located at two sides of the protruded seat.

5. The internal tooth type ratchet screwdriver according to claim 1, wherein an inner wall surface of the reversing ring is provided with a plurality of grooves; the ratchet seat is connected with a latching element through an elastic element; the latching element acts on one of the grooves; the reversing ring rotates so that the latching element shifts among the plurality of grooves.

6. The internal tooth type ratchet screwdriver according to claim 5, wherein an outer surface of the ratchet seat is provided with a recess; the latching element is mounted in the recess through the elastic element; the latching element is a steel ball.

7. The internal tooth type ratchet screwdriver according to claim 1, wherein a head part of the handle is provided with a notch; an outer wall surface of the ratchet seat is provided with a raised strip; the notch is adapted to a structure of the outer surface of the ratchet seat; the ratchet seat is inserted into the notch and fixed in circumferential and radial directions.

8. The internal tooth type ratchet screwdriver according to claim 1, wherein a head part of the handle is linked to the reversing ring; the reversing ring is linked to the ratchet head; all of the handle, the reversing ring and the ratchet head are connected by contact.

9. The internal tooth type ratchet screwdriver according to claim 1, wherein a surface of the ratchet seat is provided with a fixation element connected with a snap spring; the ratchet head is clamped at a periphery of the ratchet seat through the fixation element.
